(19) United States
(12) Patent Application Publication
(10) Pub. No.: US 2012/0228862 A1
(43) Pub. Date: Sep. 13, 2012

(54) TEMPERATURE REDUCING FLANGE FOR STEAM TURBINE INLETS

(75) Inventors: Christopher Walter Sullivan, Schenectady, NY (US); David Welch, Schenectady, NY (US); Edward Kudlacik, Schenectady, NY (US)

(73) Assignee: General Electric Company, Schenectady, NY (US)

(21) Appl. No.: 13/045,914

(22) Filed: Mar. 11, 2011

(51) Int. Cl. F01D 25/14; F16L 53/00

(52) U.S. Cl. 285/41

(57) ABSTRACT

An intermediate, temperature reducing flange is inserted between an external steam (process) connection flange and first pressure vessel, or outer shell of a turbine or a second pressure vessel, or inner shell of the turbine. The temperature reducing flange has an integral portion that is exposed to an internal turbine area that is at a lower temperature than the steam in the steam inlet port of the turbine. This portion provides for a cooling effect, thus isolating the outer shell of the turbine from the high temperature of the steam pipe. Isolating the highest temperature connections from the remainder of the outer shell allows use of lower cost alloys for the outer shell.

The present invention relates to turbines, and more particularly, to a coupling arrangement and method for isolating the outer shell of the turbine from the high temperature flange containing the main steam inlet through which high temperature steam enters a turbine.

### BACKGROUND OF THE INVENTION

Steam turbines are machines that are used to generate mechanical (rotational motion) power from the pressure energy of steam. Thus, a steam turbine's primary components are blades, which are designed to produce maximum rotational energy by directing the flow of steam along their surfaces.

A steam turbine also includes a shaft, which is a power transmitting device used to transmit the rotational movement of the blades to an AC Power generator. Surrounding the steam turbine is a shell casing, which contains the turbine and protects the turbine components from damage, and which may also support bearings on which the shaft rotates.

Steam piping brings high temperature, high pressure steam from a boiler to the turbine. The steam piping must be able to withstand all the pressure of the steam.

High temperature steam requires high strength, costly alloys be used in the turbine's construction. In a typical steam turbine outer shell, only a small portion of the large cast outer shell is actually exposed to the highest temperature. As these outer shells are typically a single casting, the entirety of the outer shell must be made of the costly material required by the high temperature. Isolating the highest temperature connections from the remainder of the outer shell allows use of lower cost alloys for the outer shell which are not specified for use with high temperature steam.

The ability to use lower cost, more common alloys in the outer shell of a steam turbine can yield significant cost savings. In addition, more suppliers would be available to provide these critical components, if they could be cast from commercial alloys.

Various styles of inlet flanges have been used in an attempt to thermally isolate the process (steam) connection from the shell material. These alternative flange designs are mounted directly to the outer shell, thus allowing a significant amount to heat transfer into the outer shell. Welded connections with active or passive cooling systems have also been used in an attempt to lower the outer shell temperature.

In high pressure steam turbines, an internal pipe with seal ring assemblies is often used to isolate the process fluid (steam) from the adjacent components and provide passage through the pressure vessels (inner and outer shells) to the turbine internal steam path. This arrangement only provides for a low degree of temperature isolation between the connection point and the shell pressure vessel.

### BRIEF DESCRIPTION OF THE INVENTION

The present invention provides for an intermediate (temperature reducing) flange being inserted between the external (process) connection flange and first (or second) pressure vessel (outer or inner shell). This temperature reducing flange has an integral portion that is exposed to an internal turbine area that is at a lower temperature than the inlet steam. This portion provides for a cooling effect, thus isolating the outer shell from the high temperature of the process piping.

In an exemplary embodiment of the invention, a coupling arrangement for isolating the shell of a steam turbine from a high temperature steam inlet port for introducing high temperature, high pressure steam into the turbine comprises a high temperature external flange containing the inlet through which the high temperature steam is introduced into the turbine from steam piping connected to a steam boiler, the external flange including at least one void containing cooling steam, and an intermediate flange connected between the shell of the turbine and the external flange, the intermediate flange including an integral part that is exposed to an internal turbine area that is at a temperature lower than the inlet steam, whereby the shell of the steam turbine is isolated from the high temperature external flange containing the high temperature steam so as to allow the use of lower cost alloys for the shell.

In another exemplary embodiment of the invention, a coupling arrangement for isolating the shell of a steam turbine from a high temperature steam inlet port for introducing high temperature, high pressure steam into the turbine comprises a high temperature external flange containing the inlet through which the high temperature steam is introduced into the turbine from steam piping connected to a steam boiler, the external flange including two solid rings with at least one void in between containing cooling steam, and an intermediate temperature reducing flange connected between the shell of the turbine and the external flange, the intermediate flange including a cooling fin that is exposed to air gaps surrounding the cooling fin that are at a temperature lower than the inlet steam, whereby the outer shell of the steam turbine is isolated from the high temperature external flange containing the high temperature steam so as to allow the use of lower cost alloys for the shell.

In a further exemplary embodiment of the invention, a coupling arrangement for isolating the outer shell of a steam turbine from a high temperature steam inlet port for introducing high temperature comprises a high temperature external flange containing the inlet through which the high temperature steam is introduced into the turbine from steam piping connected to a steam boiler, the external flange including two solid rings with at least one void in between containing cooling steam, and an intermediate temperature reducing flange connected between the shell of the turbine and the external flange, the intermediate flange including at least one internal passageway for cooling steam to circulate in the intermediate flange and a cooling fin that is exposed to air gaps surrounding the cooling fin that are at a temperature lower than the inlet steam, the cooling steam being either piped into the internal passageway from an external source through a first inlet in the intermediate flange or piped in through a second inlet in the intermediate flange from an internal cavity between an outer shell and an inner shell of the turbine flows out of an outlet on a second side of the thermal reducing flange opposite the first side, whereby the outer shell of the steam turbine is isolated from the high temperature external flange containing the high temperature steam so as to allow the use for the shell alloys which are not specified for high temperature steam.

### BRIEF DESCRIPTION OF THE DRAWINGS

FIG. 1 is a simple diagram showing the components of a typical steam turbine electricity generator.

FIG. 2 is a cross-sectional view of a coupling arrangement for isolating the high temperature steam in the steam pipe connected to the main steam inlet of the turbine from the shell casing of the turbine.

### DETAILED DESCRIPTION OF THE INVENTION

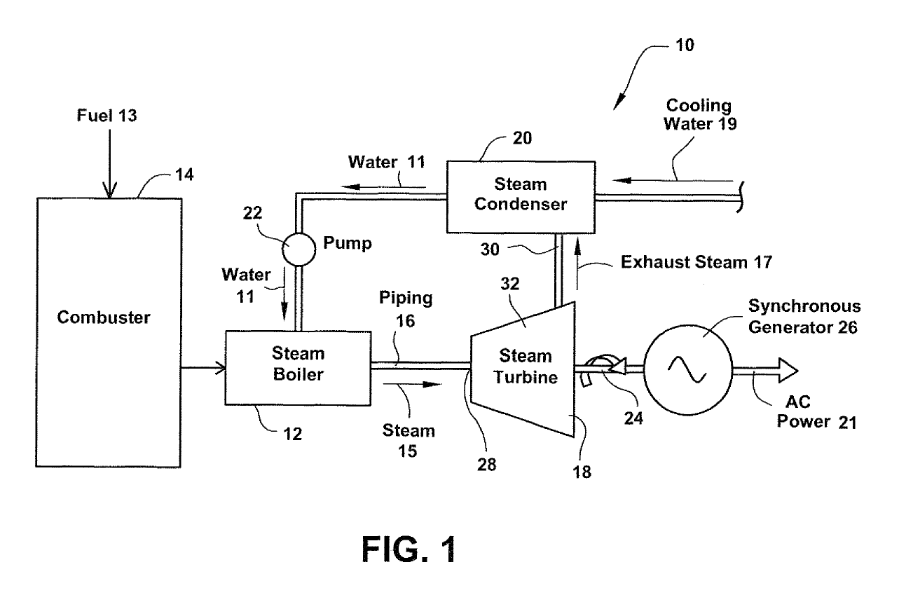

FIG. 1 is a simple diagram showing the components of a typical steam turbine system 10. The steam turbine system 10 includes a pressure vessel or steam boiler 12 in which water 11 is heated so as to produce steam 15; a combustor 14, which burns fuel 13 so as to heat the water in the steam boiler 12 to convert it into high pressure steam 15; a steam turbine 18, which extracts energy from the high temperature, high-pressure steam 15 entering the turbine 18, so as to be rotated by the high pressure steam 15; and steam piping 16, which transports the high temperature, high pressure steam 15 from the steam boiler 12 to the turbine 18. A steam condenser 20 condenses the exhaust steam 17 exiting steam turbine 18 using cooling water 19, so as to produce water 11, which is then pumped by a pump 22 back into steam boiler 12 for re-heating into steam 15.

The high pressure steam 15 is fed to the steam turbine 18 and passes along the turbine's axis through multiple rows of alternately fixed and moving blades (not shown). From the main steam inlet 28 of the turbine 18 towards the exhaust point 30, the blades and the turbine cavity are progressively larger to allow for the expansion of the steam 15. The stationary blades act as nozzles in which the steam expands and emerges at an increased speed, but lower pressure.

As the steam turbine 18 is rotated, a shaft 24 connected to the turbine 18 is caused to be rotated as well, as shown in FIG. 1. The shaft 24 is connected to the turbine 18 at one end and to a synchronous generator at the other end so as to rotate the synchronous generator 26 to thereby produce AC Power 21. The steam turbine 18's shaft 24 is a power transmitting device that is used to transmit the rotational movement of the blades of the turbine 18 to the AC Power synchronous generator 26. Surrounding the steam turbine 18 is a shell casing 32, which contains the turbine 18 and protects the turbine components from damage, and which typically supports bearings (not shown) on which the shaft 24 rotates.

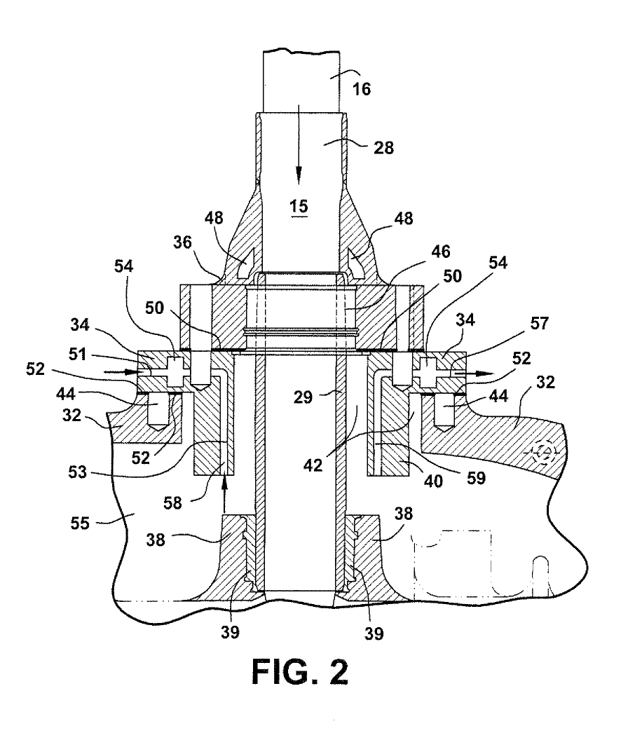

The steam piping 16 is the conduit by which the high temperature, high pressure steam 15 is conveyed from the boiler 12 to the main steam inlet 28 of the turbine 18. FIG. 2 is a cross-sectional view of a coupling arrangement for isolating the shell casing 32 of the turbine 18 from an external high temperature steam connection flange 36 containing the main steam inlet 28 through which the high temperature steam 15 from steam piping 16 enters the turbine 18. For this purpose, an intermediate, temperature reducing flange 34 is inserted between the external flange 36 containing the main steam inlet 28 and a first pressure vessel, which is the outer shell 32 of the turbine 18. Preferably, the external flange 36 is comprised of two solid rings with at least one void 48 in between containing cooling steam.

A passageway 54 in temperature reducing flange 34 allows the circulation of cooling steam in flange 34. The cooling steam is either piped in from an external source (not shown) through an inlet 51 or piped in through another inlet 53 from an internal cavity 55 between the outer shell 32 and inner shell 38 of turbine 18. If externally piped into flange 34, then the cooling steam flow would come in on one side of flange 34 through inlet 51, flow through internal passageway 54 and then flow out of the other side of the thermal reducing flange 34 through a first outlet 57. If internally piped into flange 34, then the cooling steam flow would come in on one side of flange 34 through inlet 53, flow through internal passageway 54 and then flow out of the other side of the thermal reducing flange 34 through a second outlet 59 and back into internal cavity 55.

As shown in FIG. 2, the main steam inlet 28 conveys the high temperature steam 15 into the inner shell 38 of the turbine 18 via an inlet pipe 29, which is positioned within the steam connection flange 36 by means of a solid ring bi-metallic expansion joint assembly 46. The inlet pipe 29 is connected to the inner shell 38 of the turbine 18 by an inner shell solid ring assembly 39. Preferably, the inlet pipe 29 is made from an alloy steel specified for use at high temperatures, such as the temperature at which high temperature, high pressure steam may be introduced into the main steam inlet of a steam turbine from a boiler, for example. Two examples of such an alloy steel are Chromium Molybdenum Vanadium (“Cr—Mo—V”) steel and 9-10 Cr—Mo—V steel.

The steam connection flange 36 is preferably bolted to through a gasket 50 positioned between the steam connection flange 36 and the temperature reducing flange 34. In turn, the temperature reducing flange 34 is preferably bolted to the outer shell 32 of the turbine 18 through a second gasket 52 positioned between the flange 34 and the outer shell 32. It should be noted that the bolting 44 used with the temperature reducing flange 34 needs to be able to handle both blowout loads.

Preferably, the temperature reducing flange 34 is also made from an alloy steel specified for use at elevated temperatures, as above, such as Cr—Mo—V steel and 9-10 Cr—Mo—V steel, for example. The temperature reducing flange 34 has an integral portion in the form of a barrier wall/cooling fin 40 that is exposed to an internal turbine area 42 that is at a lower temperature than the inlet steam 15. This lower temperature internal turbine area is preferably a pair of optimized air gaps surrounding barrier wall/cooling fin 40, so as to provide a cooling effect by isolating the outer shell 36 of the turbine 18 from the high temperature of the steam 15 in steam piping 16 and main steam inlet 28. Air gaps 42 are sized to maximize the Heat Transfer Coefficient (HTC) of the cooling steam.

It should be noted that the temperature reducing flange 34 could be replaced with a flange made from a type of thermal insulating material, provided this material could provide sufficient strength to withstand the pressure and bolting forces required. One example of such a flange is a Ceramic Matrix Composite (CMC) sleeve, which would be a sleeve that would not bolt into the outer shell 32, but instead be held on the outer shell 32 by a ring formed from a metal, such as steel. The bolting used with flange 36 would be pushed out, and also sit on the metal ring, such that such bolts would pass through the metal ring and then the CMC sleeve before entering the outer shell 32.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A coupling arrangement for isolating the shell of a steam turbine from a high temperature steam inlet port for introducing high temperature, high pressure steam into the turbine, the coupling arrangement comprising:
a high temperature external flange containing the inlet through which the high temperature steam is introduced into the turbine from steam piping connected to a steam boiler,
the external flange including at least one void containing cooling steam, and
an intermediate flange connected between the shell of the turbine and the external flange,
the intermediate flange including an integral part that is exposed to an internal turbine area that is at a temperature lower than the inlet steam,
whereby the shell of the steam turbine is isolated from the high temperature external flange containing the high temperature steam.

2. The coupling arrangement of claim 1, wherein the intermediate flange includes at least one internal passageway for cooling steam to circulate in the intermediate flange.

3. The coupling arrangement of claim 2, wherein the the cooling steam is either piped into the internal passageway from an external source through a first inlet in the intermediate flange or piped in through a second inlet in the intermediate flange from an internal cavity between an outer shell and an inner shell of the turbine.

4. The coupling arrangement of claim 3, wherein the cooling steam flow comes in from an external source on a first side of the intermediate flange through the first inlet, flows through the internal passageway, and then flows out of a first outlet on a second side of the thermal reducing flange opposite the first side.

5. The coupling arrangement of claim 3, wherein the cooling steam flow comes in from an internal cavity between an outer shell and an inner shell of the turbine on a first side of the intermediate flange through the second inlet, flows through the internal passageway, and then flows out of the second outlet on a second side of the thermal reducing flange opposite the first side and back into the internal cavity.

6. The coupling arrangement of claim 1, wherein the shell of the steam turbine is the outer shell of the turbine.

7. The coupling arrangement of claim 1, wherein the integral part is a cooling fin and wherein the internal turbine area that is at a temperature lower than the inlet steam is at least one air gap surrounding the cooling fin.

8. The coupling arrangement of claim 1, wherein the integral part is a barrier wall and wherein the internal turbine area that is at a temperature lower than the inlet steam is at least one air gap surrounding the barrier wall.

9. The coupling arrangement of claim 7, wherein a pair of air gaps surrounds the cooling fin.

10. The coupling arrangement of claim 1, wherein a pair of air gaps surrounds the barrier wall.

11. The coupling arrangement of claim 7, wherein a pair of air gaps surrounding the cooling fin provides a cooling effect by isolating the shell of the turbine from the high temperature steam inlet port.

12. The coupling arrangement of claim 8, wherein a pair of air gaps surrounding the barrier wall provides a cooling effect by isolating the shell of the turbine from the high temperature steam inlet port.

13. The coupling arrangement of claim 1, wherein the external flange is comprised of two solid rings with at least one void in between containing cooling steam.

14. The coupling arrangement of claim 1, wherein the intermediate flange is made from an alloy steel specified for use at high temperatures.

15. The coupling arrangement of claim 14, wherein the intermediate flange is made from Chromium Molybdenum Vanadium (“Cr—Mo—V”) steel.

16. The coupling arrangement of claim 14, wherein the intermediate flange is made from 9-10 Chromium Molybdenum Vanadium (“Cr—Mo—V”) steel.

17. The coupling arrangement of claim 1, wherein the external flange is bolted to the intermediate flange through a first gasket positioned between the external flange and the intermediate flange, and, in turn, the intermediate flange is bolted to an outer shell of the turbine through a second gasket positioned between the intermediate flange and the outer shell.

18. The coupling arrangement of claim 1, wherein the high temperature steam inlet port conveys the high temperature steam into an inner shell of the turbine via an inlet pipe that is positioned within the external flange by a solid ring bi-metallic expansion joint assembly, and wherein the intermediate flange connected between an outer shell of the turbine and the external flange isolates the outer shell of the turbine from the high temperature steam inlet port and the inlet pipe.

19. The coupling arrangement of claim 1, wherein the intermediate flange is a ceramic matrix composite sleeve, which held on the turbine shell by a metallic ring through which bolts pass before entering the shell of the turbine.

20. A coupling arrangement for isolating the shell of a steam turbine from a high temperature steam inlet port for introducing high temperature, high pressure steam into the turbine, the coupling arrangement comprising:
a high temperature external flange containing the inlet through which the high temperature steam is introduced into the turbine from steam piping connected to a steam boiler,
the external flange including two solid rings with at least one void in between containing cooling steam, and
an intermediate temperature reducing flange connected between the shell of the turbine and the external flange,
the intermediate flange including a cooling fin that is exposed to air gaps surrounding the cooling fin that are at a temperature lower than the inlet steam,
whereby the outer shell of the steam turbine is isolated from the high temperature external flange containing the high temperature steam.

21. The coupling arrangement of claim 20, wherein the intermediate flange includes at least one void for cooling steam to circulate in the intermediate flange.

22. The coupling arrangement of claim 20, wherein the intermediate flange is made from Chromium Molybdenum Vanadium (“Cr—Mo—V”) steel.

23. The coupling arrangement of claim 20, wherein the external flange is bolted to the intermediate flange through a first gasket positioned between the external flange and the intermediate flange, and, in turn, the intermediate flange is bolted to an outer shell of the turbine through a second gasket positioned between the intermediate flange and the outer shell.

24. A coupling arrangement for isolating the outer shell of a steam turbine from a high temperature steam inlet port for introducing high temperature, high pressure steam into the turbine, the coupling arrangement comprising:
a high temperature external flange containing the inlet through which the high temperature steam is introduced into the turbine from steam piping connected to a steam boiler,
the external flange including two solid rings with at least one void in between containing cooling steam, and
an intermediate temperature reducing flange connected between the shell of the turbine and the external flange,
the intermediate flange including at least one internal passageway for cooling steam to circulate in the intermediate flange and a cooling fin that is exposed to air gaps surrounding the cooling fin that are at a temperature lower than the inlet steam,
the cooling steam being either piped into the internal passageway from an external source through a first inlet in the intermediate flange or piped in through a second inlet in the intermediate flange from an internal cavity between an outer shell and an inner shell of the turbine flows out of an outlet on a second side of the thermal reducing flange opposite the first side,
whereby the outer shell of the steam turbine is isolated from the high temperature external flange containing the high temperature steam.
